(19) United States
(12) Patent Application Publication
(10) Pub. No.: US 2012/0005903 A1
(43) Pub. Date: Jan. 12, 2012

(54) PERFORATED FOOD LADLE

(76) Inventor: MELVIN M. DUNBAR, JR., Wahiawa, HI (US)

(21) Appl. No.: 13/096,872

(22) Filed: Apr. 28, 2011

Related U.S. Application Data
(60) Provisional application No. 61/344,362, filed on Jul. 6, 2010.

(51) Int. Cl. A47J 43/28

(52) U.S. Cl. 30/325

(57) ABSTRACT

A perforated food ladle includes a bowl member having a one-quart capacity. The bowl is uniformly perforated throughout its surface area. An elongate handle has its lower end attached to the rim of the bowl. The upper end of the handle terminates in a bend or hook portion. Vertically aligned capacity markings are disposed on the outer surface of the bowl.

### CROSS-REFERENCE TO RELATED APPLICATION

This application claims the benefit of U.S. Provisional Patent Application Ser. No. 61/344,362, filed Jul. 6, 2010.

### BACKGROUND OF THE INVENTION

1. Field of the Invention

The present invention generally relates to culinary utensils, and more particularly to a perforated food ladle for straining liquids from solid food.

2. Description of the Related Art

Large establishments (cafeterias, buffet dining halls, military mess halls, food kitchens, etc.) often require outsized utensils to accomplish the task of preparing food for large numbers of people. Often, the preparation problems occur when the food has to be panned-up for serving. Usually, conventional utensils are too small to accommodate the amount of food necessary to be dipped or ladled for maximum efficiency. This is especially true if liquid must be removed or strained from the food during the panning-up process. The food service industry would certainly embrace a utensil that could contain an adequate amount of food while simultaneously providing means for separating liquid from a solid-liquid food mixture during the panning-up procedure. Thus, a perforated food ladle solving the aforementioned problems is desired.

### SUMMARY OF THE INVENTION

The perforated food ladle is a ladle that includes a bowl member having a one-quart capacity. The bowl is uniformly perforated throughout its surface area. An elongate handle has its lower end attached adjacent the rim of the bowl. The upper end of the handle terminates in a bend or hook portion. Vertically aligned capacity indicia are disposed on the outer surface of the bowl.

Accordingly, the invention presents a perforated ladle having a large capacity to permit maximization of time and effort for food service personnel. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a perforated food ladle according to the present invention.

FIG. 2 is a perspective view of a perforated food ladle according to the present invention.

FIG. 3 is a top view of a perforated food ladle according to the present invention.

FIG. 4 is a rear view of a perforated food ladle according to the present invention.

Similar reference characters denote corresponding features consistently throughout the attached drawings.

### DETAILED DESCRIPTION OF THE PREFERRED EMBODIMENTS

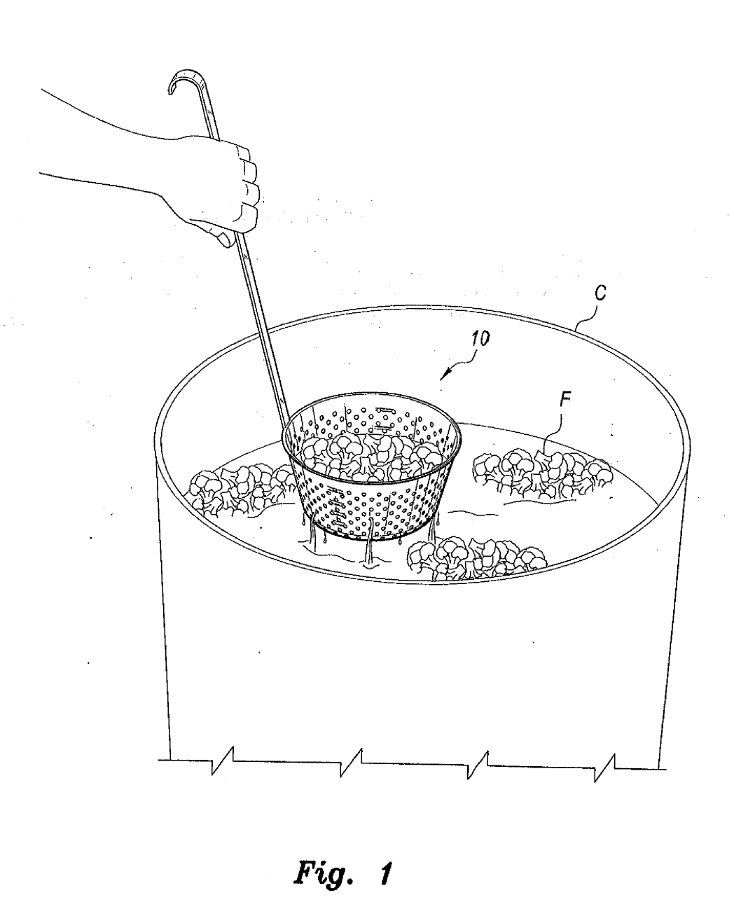

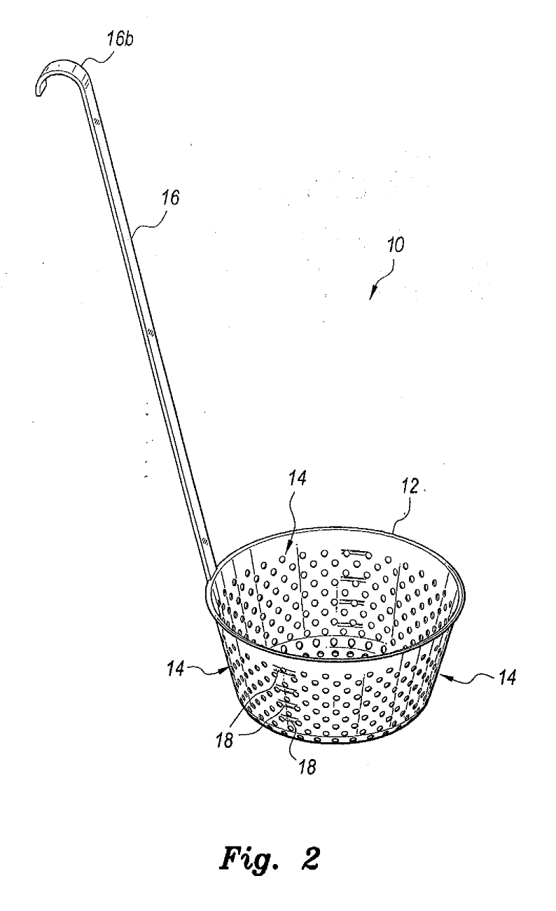

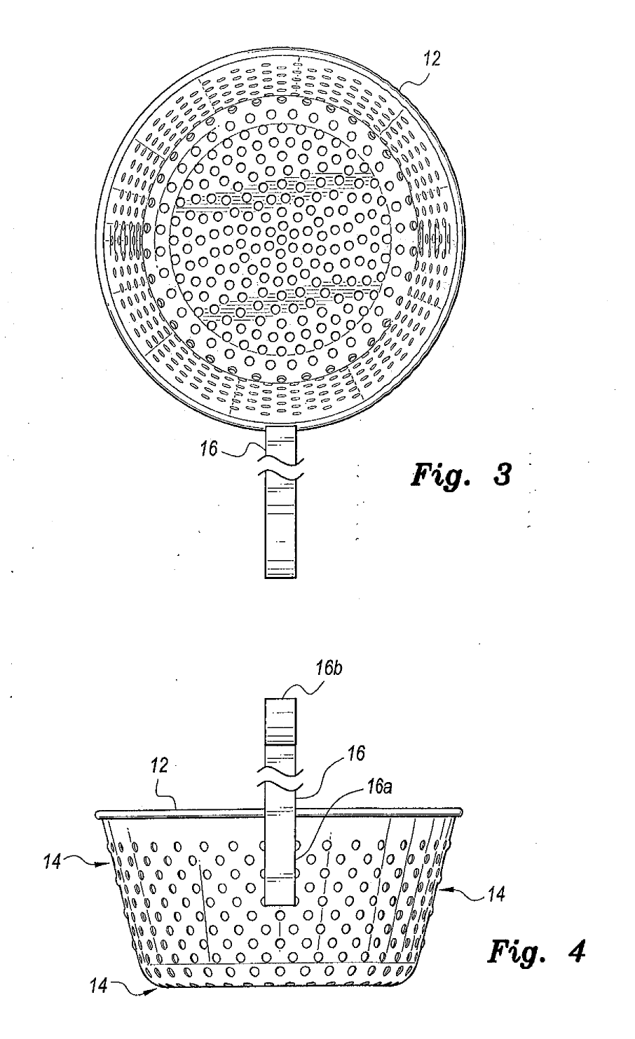

Referring to FIGS. 1-4, the perforated food ladle 10 comprises a bowl member 12 sized to contain approximately one quart of a liquid-solid mixture of food F to be panned-up from food container C. The bowl 12 is provided with perforations 14 throughout its bottom and peripheral walls to permit liquids to separate from solids during the panning-up procedure. An elongate handle 16 has a lower end 16a attached to the outer surface of bowl 12. The upper end of handle 16 terminates in a bend or hook 16b, which allows the utensil to be hung for storage when not in use. Vertically arranged indicia in the form of raised markings 18 are disposed on the outer surface of the bowl to indicate units of bowl capacity. It should be noted that other forms of indicators (numbers, letters, etc.) could be employed if desired. Although stainless steel is preferred, the utensil may be fabricated from other suitable material if desired. The one-quart capacity of the bowl has been determined to be the optimum size for handling and distribution when panning-up larger quantities of food.

It is to be understood that the present invention is not limited to the embodiment described above, but encompasses any and all embodiments within the scope of the following claims.

I claim:

1. A perforated food ladle for separating liquids from a solid-liquid mixture of food, the ladle comprising:
a bowl having an outer surface and a capacity to contain approximately one quart of the solid-liquid mixture, the bowl having a plurality of perforations defined therein to permit straining of the solid-liquid food mixture; and
an elongate handle having a lower end attached to the outer surface of the bowl.

2. The perforated food ladle according to claim 1, wherein said elongate handle has an upper end terminating in a hook.

3. The perforated food ladle according to claim 1, wherein said bowl is fabricated from stainless steel.

4. The perforated ladle according to claim 1, further including indicia vertically arranged on the outer surface of said bowl, said indicia indicating units of bowl capacity.

5. A perforated food ladle for separating liquids from a solid-liquid mixture of food, the ladle comprising:
a bowl having a bottom wall and a peripheral wall extending vertically upward from the bottom wall, the bowl having a capacity to contain approximately one quart of the solid-liquid mixture, the bottom wall and the peripheral wall having a plurality of perforations defined therein to permit straining the solid-liquid food mixture; and
an elongate handle having an upper end and a lower end, the lower end being attached to the bowl.

6. The perforated food ladle according to claim 5, wherein the upper end of said elongate handle terminates in a hook.

7. The perforated food ladle according to claim 5, wherein said bowl is fabricated from stainless steel.

8. The perforated food ladle according to claim 5, wherein said bowl has an outer surface. said bowl further including indicia vertically arranged on the outer surface of said bowl, the indicia indicating units of bowl capacity.

9. The perforated food ladle according to claim 5, wherein said bowl has an outer surface, the lower end of said handle being attached to the outer surface.

10. A perforated food ladle for separating liquids from a solid-liquid mixture of food, the ladle comprising:
a bowl having a bottom wall and a peripheral wall extending upward from the bottom wall, the peripheral wall having an outer surface, the bowl s having a capacity to contain approximately one quart of the solid-liquid mixture, the bottom wall and the peripheral wall having a plurality of perforations defined therein to permit straining liquid from the solid-liquid food mixture;
an elongate handle having an upper end and a lower end, the lower end being attached to the outer surface of the peripheral wall, the upper end forming a hook; and
indicia in the form of raised markings vertically arranged on the outer surface of the peripheral wall, the indicia providing graduation marks in units of bowl capacity.

11. The perforated food ladle according to claim 10, wherein said bowl is fabricated from stainless steel.
